(19) United States
(12) Patent Application Publication
(10) Pub. No.: US 2007/0078565 A1
(43) Pub. Date: Apr. 5, 2007

(54) Telerobotic system that transmits changed states of a subsystem

(76) Inventors: Modjtaba Ghodoussi, Santa Barbara, CA (US); Chris M. Truax, Mt. Helix, CA (US)

Correspondence Address: Kenneth L. Stein, 402 East Gutierrez, Santa Barbara, CA, 93101, US

(21) Appl. No.: 11/243,063

(22) Filed: Oct. 3, 2005

(51) Int. Cl. G06F 19/00

(52) U.S. Cl. 700/245; 700/264

(57) ABSTRACT

A telerobotic system includes a user operated input device and a distantly located robotic system. The robotic system is in communication with the input device through a communication channel. The input device transmits information relating to the current state of the input device only when the current state differs from a just previous current state. The robotic system receives such transmitted information and changes state in response thereto. The robotic system may be operatively connected to a second input device to mechanically drive the second input device. The second input device, in communication with a second robotic system via a second communication channel, may then drive the second robotic system. As such, a user manipulating the input device effectively operates the second robotic system.

### BACKGROUND OF THE INVENTION

1. Field of the Invention

The present invention generally relates to robotic systems. More particularly, the present invention relates to telerobotic systems. Even more particularly, the present invention relates to a telerobotic system for performing medical procedures.

2. Description of Related Art

Telerobotic systems generally include an input device and a distantly located robotic system. A human operator is positioned at and manipulates the input device. The input device includes sensors to sense and generate data representative of its current configuration. The input device and robotic system communicate via a communication channel which may be provided via land-lines or wireless (including satellite) provisioned services and, dependant upon the application, may be selected based upon supported bit rates. Current input device configuration data is transmitted from the input device across the communication channel to the robotic system. The robotic system receives the configuration data and operates accordingly.

The robotic system, in turn, generates signals indicative of its present state, and transmits such to the input device. The state of the input device and the robotic system are each encoded using an absolute data-coding scheme. Absolute data reflects the current state of the input device, or robotic system, without reference to the previously known state.

Medical robotic systems such as the ZEUS® surgical robotic system, produced by Intuitive Surgical, Inc. of Sunnyvale, Calif. enable and enhance the performance of some minimally invasive surgical procedures. The ZEUS® system includes an input device (a pair of handles and a foot pedal), a communication channel, and a distantly located robotic system. See published U.S. patent application Ser. No. 2003144649, published Jul. 31, 2003, naming the inventors Ghodoussi et al., incorporated herein by reference, for a description of the ZEUS® system (the “ZEUS Reference”). Additionally, see U.S. Pat. No. 5,762,458 issued to Wang et al., and assigned to Intuitive Surgical of Mountainview, Calif. and which is incorporated herein by reference in its entirety, and which teaches the general operation of such a system.

Historically, and as taught in the ZEUS Reference, telerobotic systems have operated by transmitting the complete present state of the input device to the robotic system. As such, if a set of absolute data is lost during transmission, the robotic system can recover upon receipt of the next data set. The robotic system must achieve the new configuration in time to ensure continuous proper function. Depending upon the amount of data lost, the time necessary for the robotic system to “catch up” and achieve the configuration specified by the received control signals represents a design challenge and a limitation to the functioning of such a system.

Teleoperated systems like the ZEUS system do not employ what is known as a relative data-coding scheme. Relative data represents the relation between the current state and just previous state. When a set of relative data is lost during transmission, the next received set of relative data will fail to appropriately drive the robotic system. Because relative data is defined with regard to recently transmitted data, a failure in the transmission of even a single set of such relative data can result in robotic system misoperation. As such, telerobotic systems employ an absolute encoding scheme or transmission protocols that guarantee delivery of such data.

The great variability in the operation of telerobotic systems makes interoperation between elements of different telerobotic systems nearly impossible without system redesigns. One finds customized input devices, communication systems and distantly positioned robotic systems are not amenable to the plug-and-play type facilities one finds with modem day personal computers and the like. The capability to control a variety of telerobotic systems using a standardized input device would provide for usage across such systems.

Therefore, what is needed in the art is a method for minimizing data transmission while at the same time increasing the operating integrity of telerobotic systems. Additionally, what is needed is a configurable input device for operating a variety of teleoperated systems.

### SUMMARY OF THE INVENTION

It is to the solution of the hereinabove mentioned problems to which the present invention is directed. In accordance with the present invention there is provided a telerobotic system comprising:

an input device, said input device comprising a plurality of discretely representable state configurations, said input device configured to a current one of said plurality of discretely representable state configurations, said input device further configurable to a next current one of said plurality of discretely representable state configurations, wherein said current one of said plurality of discretely representable state configurations is represented as a relation between the current one of said plurality of discretely representable state configurations and a just previous current one of said plurality of discretely representable state configurations;

a controller for processing and transmitting data indicative of the current one of said plurality of discretely representable state configurations, wherein said controller transmits said data given that said current one of said plurality of discretely representable state configurations is not equal said just previous current one of said plurality of discretely representable state configurations; and

a robotic system positioned distantly said input device and in electrical communication with said controller, said robotic system configured to receive transmitted data indicative of said current one of said plurality of discretely representable state configurations.

Disclosed herein is a telerobotic system including an input device, a controller, and a distantly located robotic system comprising at least one receiver. The input device may comprise a handle disposed a console and at least one sensor for measuring the positioning of the handle relative to the console. The handle is positionable by a user to occupy one of a plurality of discretely definable configurations. The at least one sensor establishes current state information relating to the input device. More particularly the at least one sensor may establish current state information relating to the handle position relative to the console.

An input device controller transmits the current state information upon the condition that the current state information differs from the just previous current state information. As such, the input device may transmit only that subset of current state information that differs from the just previous current state information. The distantly positioned robotic system includes a receiver for receiving transmitted current state information. The robotic system receives and operates in accordance with transmitted current state information. The input device transmits only such state information that is representative of a changed state of the input device to insure that the robotic system receives only pertinent commands, data, etc. necessary to operate properly.

Transmitted state information relating to the position is encoded as absolute position data. Such data is taken relative to an initialized starting point and not relative to the last transmitted positional data. As such, if data is lost in transmission or if data arrives at the recipient input device or robotic system out of sequence, the system 10 can continue to operate and maintain required performance levels.

A robotic system in accordance with the present invention may be operatively connected to a second input device. As such, user manipulation of the input device effectively drives the operation of the second input device through the robotic system. The second input device may be connected to a second robotic system thereby enabling user control of the second robotic system by manipulating the input device.

For a more complete understanding of the present invention, reference is made to the following detailed description and accompanying drawings. In the drawings, like reference characters refer to like parts, in which:

### BRIEF DESCRIPTION OF THE DRAWINGS

FIG. 1 is a plan view of a telerobotic system in accordance with a preferred embodiment of the present invention;

FIG. 2 is a perspective view of an input device handle assembly of a preferred embodiment in accordance with the present invention;

FIG. 3 is a plan view of a telerobotic system used to control a second telerobotic system in accordance with the present invention; and

FIG. 4 is a schematic showing various fields of a data packet in accordance with the present invention.

### DESCRIPTION OF THE PREFERRED EMBODIMENTS

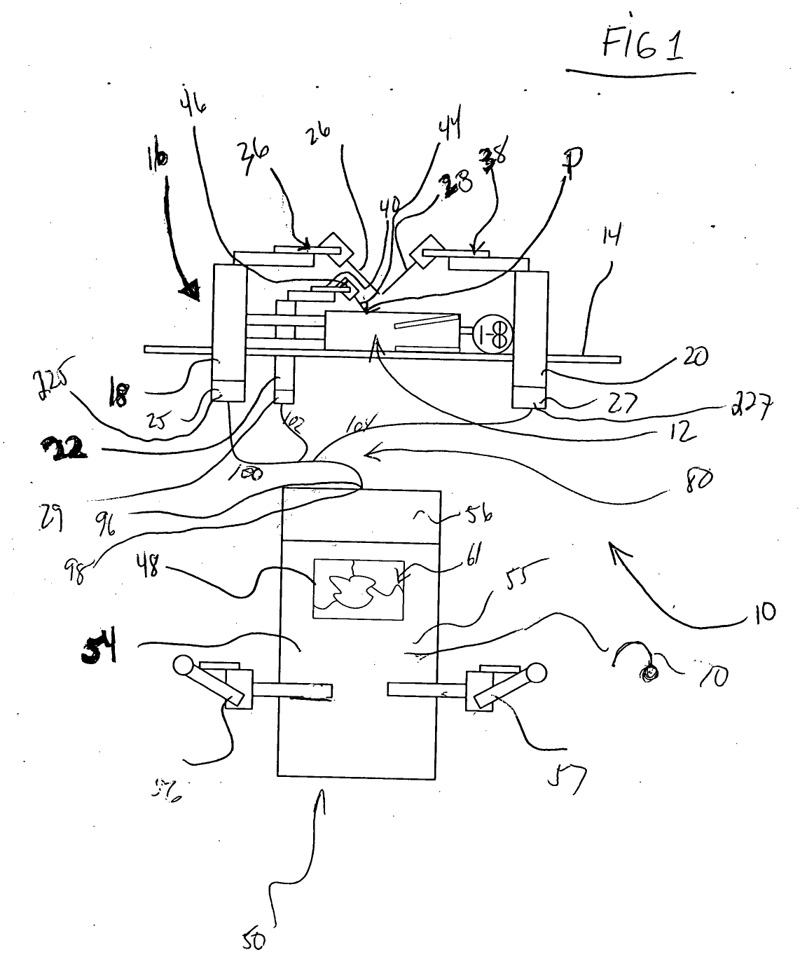

Referring to the drawings more particularly by reference numbers, FIG. 1 shows a telerobotic system 10 in accordance with the present invention that can be used to perform minimally invasive surgery. For example, the system 10 can be used to suture a pair of vessels. The system 10 can be used to perform a procedure on a patient 12 that is typically lying on an operating table 14. A robotic system 16 comprises a first articulate arm 18, a second articulate arm 20 and a third articulate arm 22, each of which are mounted to the operating table 14 in a spaced apart relationship. The articulate arms 18, 20, 22 are preferably mounted to the operating table 14 so that the arms are disposed the same reference plane as the patient 12. Each articulate arm 18, 20, 22 has a respective input 25, 27, 29 for receiving control signals which shall be described in detail hereinbelow. Although three articulate arms 18, 20, 22 are shown and described, it is to be understood that the robotic system 16 may have any number of arms.

The first 18 and second 20 articulate arms may each have a surgical instrument 26, 28 coupled to robotic arms 36, 38 respectively. The articulate arm 22 includes a robotic arm 40 that holds and moves an endoscope 44. The surgical instruments 26, 28 and endoscope 44 are inserted through incisions cut into the skin of the patient 12. The endoscope 44 has a camera 46 that is electrically coupled to a video console 48 for displaying images of the internal organs of the patient 12 thereupon.

The system 10 generally includes an input device 50. The input device 50 comprises a controller 54 and at least one handle assembly 56. Given the application to which the preferred embodiment of the present invention is directed, namely use in performing surgical procedures, the at least one handle assembly 56 preferably comprises first and second handle assemblies 56, 57. Each handle assembly 56, 57 is used to control the movement and positioning of at least a selected one of the robotic arms 36, 38, or 40. By manipulating each of the first and second handle assemblies 56, 57, the user, in this case preferably a surgeon, is able to perform a surgical procedure that takes place distant the input device 50 as described hereinbelow.

In the preferred embodiment, the controller 54 is disposed a cabinet 55 containing electrical circuits such as processor(s), memory, I/O interfaces, drivers, signal type converters etc., that generate and transmit control signals for receipt at the inputs 25, 27, 29 of the articulate arms 18, 20, 22. The control signals include data for controlling the movement and actuation of the surgical instruments 26, 28 and endoscope 44, and other related data.

The movement, positioning and actuation of more than one instrument 26, 28 may be alternatingly effectuated by each of the first and second handle assemblies 56, 57 of input device 50. A toggle, button, or some other switch, well known to those skilled in the art, may be employed with respect to each of the first and second handle assemblies 56, 57 enabling the selected control a selected one of the instruments 26, 28 and endoscope 44 and shall not be further described herein.

The input device 50 is in master-slave relationship with the articulate arms 18, 20. Movement of the first and second handle assemblies 56, 57 of the input device 50 produces input data indicative thereof. The input data is electrically communicated to the controller 54 which compares the input data with the input data received immediately prior thereto. The controller 54 then calculates a proportional movement for the corresponding surgical instrument 26, 28 and generates control signals to move the robotic arms 36, 38 and instruments 26, 28. Where there has been no change in the input signal relative to the last received input signal, the controller 54 does not generate any corresponding control signal representative of the unchanged data as such data does not need to be transmitted.

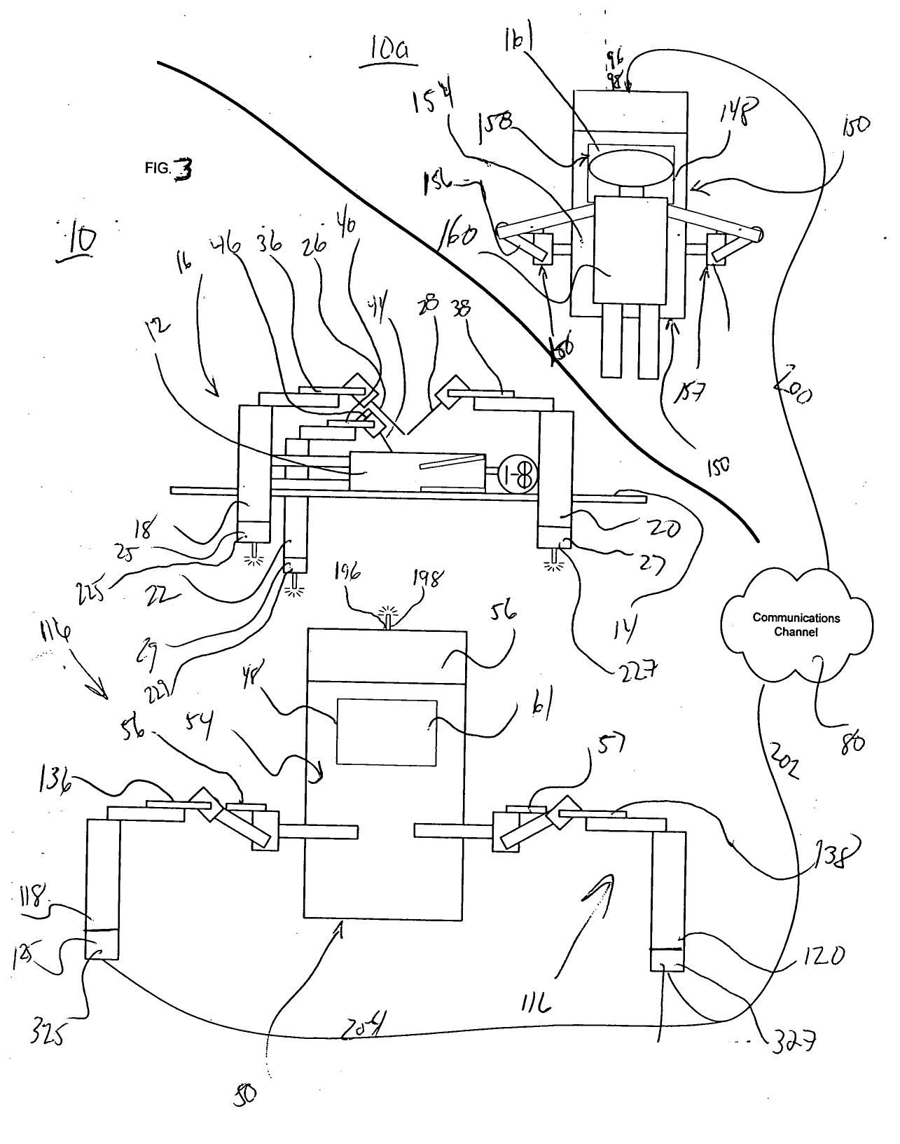

As depicted in FIG. 3, there is a nested configuration wherein a controller 154 generates control signals for that input data that varies from the previous received input data and transmits such onto a communications channel 80. The control signals are received by the robotic system 116 at inputs 325, 327 where they drive the actions of the robotic arms 136, 138. The movements of the robotic arms 136, 138 act as input to the telerobotic system 10 for the operation thereof.

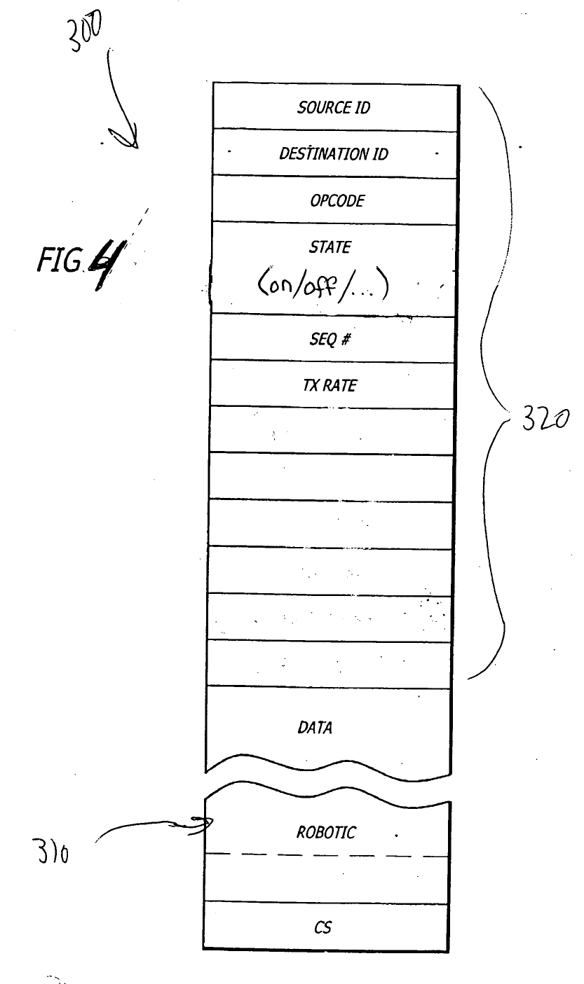

As illustrated in FIG. 4, the controllers 54, 154 packetize the data for transmission. Each packet 300 contains two types of data, robotic data 310 and other needed non-robotic data 320. Robotic data 310 includes position information of the robots 36, 38, 40 including command signals to move the robots 36, 38, 40 and position feedback from the robots 36, 38, 40. Both control signals and position feedback are represented as absolute position data. Control signals are generated by each controller 54, 154 and the position feedback data is generated by a corresponding robotic arm 36, 38, 40, 136, 138 and transmitted at the corresponding robotic arm's output 225, 227, 229, 325, 327 to the controller 54, 154. Such is indicated by the placement of a controller ID as the destination ID while the source ID holds the ID for the robotic arm transmitting such feedback information.

Each packet may have the fields shown in FIG. 4. The SOURCE ID field includes identification information of the input device or medical device from where the data originates. The DESTINATION ID field includes identification information identifying the input device or medical device that is to receive the data. The OPCODE field defines the type of commands being transmitted. The SEQ # field provides a packet sequence number so that the receiving device can determine whether the packet is out of sequence. The TX Rate field is the average rate at which packets are being transmitted. The RX Rate field is the average rate that packets are being received. The DATA field contains data being transmitted and contains a separate subfield for robotic data. CS is a checksum field used to detect errors in the transmission of the packet.

Other data may include functioning data such as instrument scaling, instrument actuation, force sensing, motor current, wherein such data is selected depending on how the system 10 is being used. Each controller 54, 154 can use relative or absolute positional data to determine whether there has been an indicated change of position in the handle assemblies 56, 57, 156, 157.

Because each controller 54, 154 generally transmits absolute position data to the robotic system 16, 116 the packetized robot data can be received out of sequence. This may occur when using a UDP/IP protocol that employs a best efforts methodology. The articulate arms 18, 20, 118, 120 and the controllers 54, 154 are constructed and configured to properly handle any “late” arriving packets that contain robotic data.

As a means of example, the controller 54 may sequentially transmit first, second and third data packets. The destination articulate arm 18 receives the data packets at its input 225 in the order of first, third and then second. The destination articulate arm 18 can disregard the second packet. Disregarding the second packet provides a more efficient network protocol thereby reducing system latency. It is desirable to minimize latency to create “real time” operation of the system.

To ensure that controller 54 transmitted data was received by the distant robotic system 16, the controller 54 can be configured to send each packet a number of times equal to or greater than the maximum number of packets that may be lost sequentially by a network. Using a priori knowledge of a network, it is well known in the art how to calculate the maximum number of sequentially transmitted packets that may be lost.

Alternatively, the distantly positioned robotic system 16, upon receiving and error checking incoming data from the controller 54, may generate ‘received ok’ data corresponding to an associated received data packet. The robotic system 16 then transmits the ‘received ok’ data to the controller 54

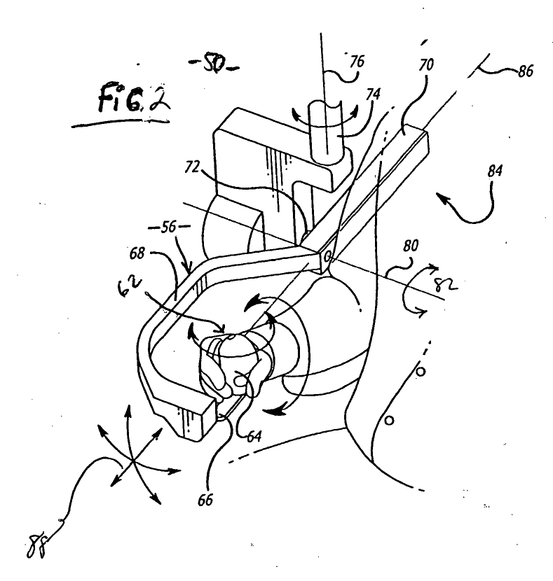

With respect to the generation of input, there is depicted in FIGS. 1 and 2 the at least one handle assembly 56 of the input device 50. The handle assemblies 56, 57 are coupled to the controller 54 and are configurable to occupy a current one of a plurality of discretely representable state configurations. The controller 54 is electrically coupled to robotic arms 36, 38 and medical instruments 26, 28 through electrical cables 100, 102, 104.

Alternatively, and as depicted in FIG. 3, the controller 154 may be in communication with at least a pair of articulate arms 118, 120 across a network based communications channel via cables 200, 202, 204. The communications channel can be any type of communication system including but not limited to the internet and other types of wide area networks (WANs), intranets, local area networks (LANs), public switched telephone networks (PSTN), integrated services digital networks (ISDN), and satellite communications. It is preferable to establish a communication link that provides certain quality of service features such as minimized latency variation.

Each controller 54, 154 includes one or more microprocessors, memory devices, drivers, etc., that function to convert user input into a set of control signals. However, prior to the generation of such, the controller 54, 154 compares the input signals with stored signals representative of the last received set of input signals. Where there has been no indicated change in an input signal with the one immediately prior to that, the controller 54, 154 acts to filter out such unchanged input signals. The controller 54, 154 includes an input and output 96, 98, 196, 198 for transmitting control signals to the corresponding robotic system 16, 116 and for receiving robot data from the corresponding robotic system 16, 116.

When in use and as shown in FIG. 1, a surgeon and the at least one handle assembly 56, 57 may be positioned in front of the video console 58. The video console 58 may be in electrical communication with the endoscope camera 46 such that images acquired from the endoscope 44 are displayed in a video console screen 61. Captured images are communicated to the screen 61 via the communication channel disclosed hereinabove. The video console 58 is configured to receive and pass on such video signals. To improve performance in the system, the video data can be multiplexed with the robotic/other data onto the communication network. The video data may be compressed using conventional compression techniques for transmission to the surgeon side of the system including MPEG, MPEG2, QuickTime and other appropriate formats.

The input device 50 may further have a microphone 70 to accept voice commands. One or more voice commands may be used to move the endoscope 44. Other voice commands can be used to vary parameters of the system 10, access patient information from a hospital network, or communicate with other surgeons located remote both the surgeon and the patient.

The nested configuration depicted in FIG. 3 includes the system of FIG. 1 and a pair of articulate arms 118, 120 that manipulate the at least one handle assemblies 56, 57. A surgeon 60 is disposed at an input device 150 having a controller 154 in communication with the articulate arms 118, 120 through a communication channel 80. Input device 150 transmits information onto and through the communication channel 80.

The input device 150 transmits and receives robot data in the same way as disclosed hereinabove with respect to input device 50. However, control signals from the controller 154 do not directly control the movements of articulate arms 18, 20, 22. Instead, the control signals are used to control the input articulate arms 118, 120 that in turn physically manipulate the at least one handle assemblies 56, 57 of the input device 50. Force reflection data, changes in position and the like are all translatable through the input articulate arms 118, 120 as each can be designed to be backdrivable.

It is preferable that certain data be received in strict sequential order at the articulate arm inputs 25, 27, 29, 125, 127. Therefore, the receiving articulate arm will request a re-transmission of such data from the corresponding controller 54, 154 if the data is determined to be corrupt. Determining data corruption includes the use of checksums and other well-known means and as such shall not be further discussed here.

In operation, the system initially performs a start-up routine. The system 10 is typically configured to start-up with data from the input devices 50, 150. The input device 50, 150 may not be in communication during the start-up routine of the robotic arms 36, 38, 40, 136, 138, 140, instruments, etc. therefore input device 50, 150 data required for system boot-up is missing. The robotic systems 16, 116 may automatically drive the missing input device 50, 150 data to default values. The default values allow the patient side of the system to complete the start-up routine. Likewise, the input device 50, 150 may also drive missing incoming signals to default values to allow the input devices 50, 150 to boot-up. Driving missing signals to a default value may be part of a network local mode. The local mode allows one or more input devices to “hot plug” into the system without shutting the overall system down.

Additionally, if communication between the input device 50 or 150 and its corresponding robotic system 16, 116 are interrupted during operation, the input device 16, 116 will again force the missing data to the last valid or default values or any other “safe” value preventing the systems from shutting down or moving unwantedly, as appropriate. The default values may be quiescent signal values to prevent unsafe operation of the system. The components of the robotic system will be left at the last known good value so that the instruments and arms maintain proper operation.

Conversely, each robotic arm will obtain feedback information, etc. of the arm during a sample period and then send the entire changed state information over the network. The feedback represents the state of the changes in robot's joints, motors, currents during a sampling period. In general, a state is a status of a subsystem collected during the sampling period. With the “state” transmission approach the receiving unit will have all of the information required to process the state of the transmitting unit. For example, the robotic arm will receive state information regarding each position state of the handle before processing and executing the received information from an input device. The arm will not process data until all relevant state information is received through the network.

While certain exemplary embodiments of the present invention have been described and shown on the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. As such, what is claimed is:

1. A telerobotic system comprising:
an input device, said input device comprising a plurality of discretely representable state configurations, said input device configured to a current one of said plurality of discretely representable state configurations, said input device further configurable to a next current one of said plurality of discretely representable state configurations, wherein said current one of said plurality of discretely representable state configurations comprises a relation between the current one of said plurality of discretely representable state configurations and a just previous current one of said plurality of discretely representable state configurations;
a controller for processing and transmitting data indicative of the current one of said plurality of discretely representable state configurations, wherein said controller transmits said data given that said current one of said plurality of discretely representable state configurations differs said just previous current one of said plurality of discretely representable state configurations; and
a robotic system positioned distantly said input device and in electrical communication with said controller, said robotic system configured to receive transmitted data indicative of said current one of said plurality of discretely representable state configurations.

2. The telerobotic system of claim 1 wherein said current one of said plurality of discretely representable state configurations is generated by a user.

3. The telerobotic system of claim 1 wherein said current one of said plurality of discretely representable state configurations comprises a plurality of substates.

4. The telerobotic system of claim 1 wherein said distantly positioned robotic system is configured for attachment a distantly positioned input mechanism.

5. The telerobotic system of claim 1 wherein said controller ceases processing data indicative of the current one of said plurality of discretely representable state configurations if said current one of said plurality of discretely representable state configurations varies relative said just previous current one of said plurality of discretely representable state configurations.

6. The telerobotic system of claim 3 wherein at least one of said plurality of substates comprises a relation state between the current one of said plurality of discretely representable state configurations and a just previous current one of said plurality of discretely representable state configurations;

7. The telerobotic system of claim 6 wherein said relation state comprises a boolean indicating as different the current one of said plurality of discretely representable state configurations and a just previous current one of said plurality of discretely representable state.

8. The telerobotic system of claim 1, wherein said controller transmits data comprising absolute position data.

9. The telerobotic system of claim 1, wherein said controller transmits data comprising relative position data.

10. A telerobotic system comprising:
an input device, said input device comprising a plurality of discretely representable state configurations, said input device presently configured to a current one of said plurality of discretely representable state configurations, said input device further configurable to a next current one of said plurality of discretely representable state configurations, and said input device having been configured to a just previous current one of said plurality of discretely representable state configurations immediately prior to said current one of said plurality of discretely representable state configurations;
a controller for processing and transmitting data indicative of the current one of said plurality of discretely representable state configurations, wherein said controller transmits said data given that said current one of said plurality of discretely representable state configurations is not equal said just previous current one of said plurality of discretely representable state configurations; and
a robotic system positioned distantly said input device and in electrical communication with said controller, said robotic system configured to receive transmitted data indicative of said current one of said plurality of discretely representable state configurations

11. The telerobotic system of claim 10 wherein said current one of said plurality of discretely representable state configurations is generated by a user.

12. The telerobotic system of claim 10 wherein said current one of said plurality of discretely representable state configurations comprises a plurality of substates.

13. The telerobotic system of claim 10 wherein said distantly positioned robotic system is configured for attachment a distantly positioned input mechanism.

14. The telerobotic system of claim 10 wherein said controller ceases processing data indicative of the current one of said plurality of discretely representable state configurations if said current one of said plurality of discretely representable state configurations varies relative said just previous current one of said plurality of discretely representable state configurations.

15. The telerobotic system of claim 12 wherein at least one of said plurality of substates comprises a relation state between the current one of said plurality of discretely representable state configurations and a just previous current one of said plurality of discretely representable state configurations;

16. The telerobotic system of claim 15 wherein said relation state comprises a boolean indicating as different the current one of said plurality of discretely representable state configurations and a just previous current one of said plurality of discretely representable state.

17. The telerobotic system of claim 10, wherein said controller transmits data comprising absolute position data.

18. The telerobotic system of claim 13, wherein said input mechanism is a hand controller.

19. The telerobotic system of claim 18 wherein said hand controller is a game pad.

20. The telerobotic system of claim 1, wherein said controller transmits data comprising relative position data.
